(19) United States
(12) Patent Application Publication
(10) Pub. No.: US 2008/0021774 A1
(43) Pub. Date: Jan. 24, 2008

(54) MEDIA POPULARITY CONTEST METHOD

(76) Inventor: Steven N. Verona, Penn Valley, PA (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 11/781,516

(22) Filed: Jul. 23, 2007

Related U.S. Application Data
(60) Provisional application No. 60/832,392, filed on Jul. 21, 2006.

(51) Int. Cl. G06Q 30/00

(52) U.S. Cl. 705/14

(57) ABSTRACT

A method of encouraging the submission of media content to a web site for viewing by others. The encouragement is provided by the offer of awards, such as money or prizes, to the content that is deemed the most popular, which can be by counting the number of times each content file is viewed. The most popular content file is given notoriety and the provider of the content is awarded the prize. Multiple prizes can be awarded. Accounts can be set up to accept award money, and to pay any fees charged to submit content files.

### CROSS-REFERENCES TO RELATED APPLICATIONS

This application claims the benefit of U.S. Provisional Application No. 60/832,392 filed Jul. 21, 2006.

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

1. Field of the Invention

This invention relates generally to a method for encouraging and rewarding the submission of desirable media content to the public.

2. Description of the Related Art

It is well known that large production companies are formed for the purpose of providing content such as musical recordings, films, and magazines, among others, to entertain and educate consumers. The cost of producing the content is underwritten in one of many ways. For example, a third party may pay for the right to show the content to consumers who pay for viewing it. This occurs, for example, in the making of films that are shown in theaters that charge a fee for admission. Alternatively, third parties purchase the content and show it without charge, but show advertisements during breaks in the content. These third parties are paid by advertisers whose advertisements are shown. This occurs, for example, in broadcast television programs. The same applies to broadcast radio. Music production companies recoup their costs of production and obtain profit from radio stations and others who pay for the right to play the musical recordings. Nevertheless, all of these conventional producers of content have enormous costs associated not only with creating the content, but also with distributing it. These costs create a barrier to entry into the market for many artists who would produce content that could be enjoyed by consumers.

Using the Internet, hundreds of millions of consumers can connect to a content provider's web site to view the content produced by the provider or anyone else. Because it is inexpensive to create a web site, the Internet has decreased the cost to distribute content. Additionally, anyone with a digital still or video camera can create content. Thus, there are potentially many more producers of content than ever before. However, not all content is worthy of viewing, and not all web site administrators can take the time to view and rate all content submitted. Furthermore, gaining the attention of a large audience looking at millions of web sites is not easy or inexpensive. Thus, the distribution of content is still costly using most conventional methods. Therefore, the need exists for a means by which content can be shared with a wide audience.

### BRIEF SUMMARY OF THE INVENTION

The invention contemplates a method of tracking media content to determine the popularity of content in order to award prizes to people who submit frequently viewed content for others. The method can be used in conjunction with existing web sites or incorporated into a web site made just for the purpose of the invention. The incentive to create and provide content is the potential for receiving an award and the possibility of wide exposure of the content. Additionally, consumers assist in making good content stand out using the tracking step, which rates or ranks the content. Finally, all consumers benefit, because more content is created and made widely available, and the ranking system permits consumers to view only highly rated content.

### BRIEF DESCRIPTION OF THE SEVERAL VIEWS OF THE DRAWINGS

FIG. 1 is a flow chart illustrating the steps of the preferred embodiment of the present invention.

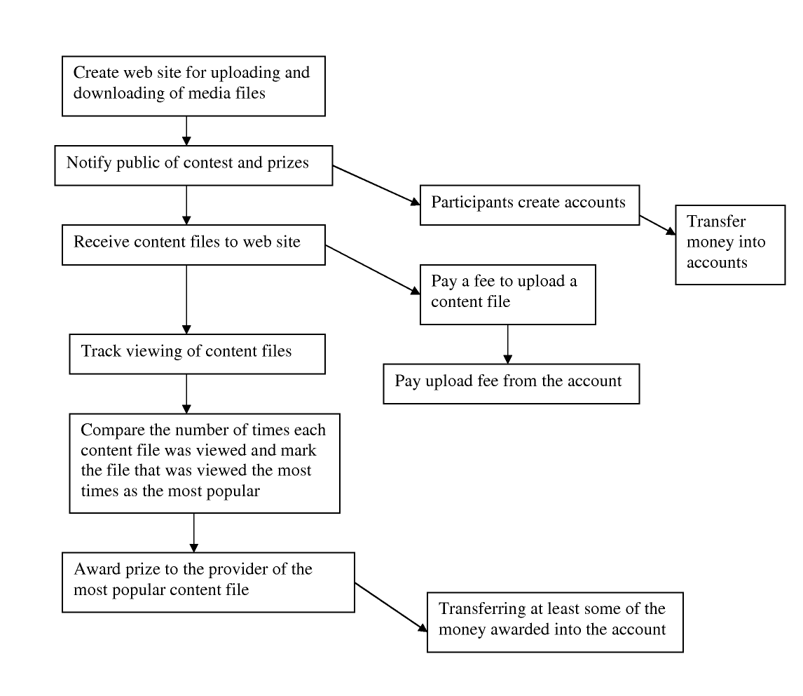

In describing the preferred embodiment of the invention, which is illustrated in the drawings, specific terminology will be resorted to for the sake of clarity. However, it is not intended that the invention be limited to the specific term so selected and it is to be understood that each specific term includes all technical equivalents that operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

In a basic embodiment of the invention, a well-known web site encourages people to upload content to the web site by promising prizes to the content that ends up being viewed the most over a period of time. This can be accomplished by a web site company advertising on its own web site, on television or radio, or using a publicity-attracting “stunt”, communicating to the public at large that it wishes for content producers to submit their content to the web site for viewing by others. This encouragement to upload content can be considered a “contest”, although it need not be referred to as one. The web site company makes available to content providers a conventional mechanism for uploading their content, such as audio recordings, video recordings, still videos, animation and other content, to the web site in the form of a digital file.

Once a provider's content is uploaded, it is made available to others to view in a conventional manner. Typically the viewing by others is with no charge, so that consumers are not hindered by the cost involved in viewing the content, but it is contemplated that a charge may be incurred for viewing. Conventional software, which tracks the number of times a particular digital file is accessed via the internet, is used to maintain records on each file's “popularity”, i.e., the number of times each file has been viewed, which includes merely listening to or otherwise sensing the contents of digital files that do not have visual material to be “viewed”. It is preferred that the software has the ability to track the number of different consumers who view the file, whether the entire file was viewed, and other factors that could be used to make a more accurate assessment of popularity than simply the total number of times the file was accessed via the internet. Such factors as this can be weighed using an algorithm that places, for example, more value on the amount of the file that is viewed versus whether different viewers view the file, and is used to determine which file is the “most popular”. Thus, the “most popular” file can be determined by a sophisticated algorithm that weighs many factors, but such detailed tracking is not necessary to the invention because the “most popular” file can be the one that is simply accessed the most times.

Once the time period of the “contest” has passed, a person, or a computer or other mechanism, compares the total number of viewings for all of the files that were uploaded as part of the contest, and the content provider whose file has the highest number of viewings wins a prize. Alternatively, as discussed above with sophisticated software that tracks more than the number of times the file was accessed, some other measures of popularity are used to determine the “winner”.

The fact that the content provider's file won the contest is also released publicly, such as using a press release, on the web site, in advertising and other such means. Such publicity increases interest in viewing the file and likely will generate even more viewing by consumers. Thus, anyone submitting content has the possibility of receiving substantial viewing of his or her content that would otherwise cost a substantial amount of money, or require signing a contract with a production company that minimizes the control the content provider has over his or her content.

It is also contemplated that there can be multiple prizes, such as a grand prize, and prizes for first place, second place and third place. The number of prizes is not critical, and there can be dozens of prizes, in addition to the prize for the most popular. Also, there can be specialty prizes, such as a prize for the file viewed the most times by the same viewers, the file viewed in its entirety by the most viewers, and many other prizes that can be determined from information gathered automatically and manually.

In one variation of this embodiment, people who submit photos or videos for viewing are charged a fee to be entered into the contest. The fee may be very small, such as one dollar. This nominal fee provides a disincentive to content providers who would otherwise submit content that is essentially worthless. By reducing the number of content providers to those who are serious, the contest becomes more appealing to consumers. Additionally, the small fee provides a revenue stream to underwrite costs associated with the contest. In a preferred embodiment, participants pay a fee to enter the contest, and a portion of the money collected as entry fees is paid out as prizes. In a most preferred embodiment, the amount of money collected in fees exceeds the amount of money paid out as prizes, thereby generating a profit. The incentive of gaining notoriety will cause providers to submit content, and the submission in a contest of content that proves popular results in a financial reward to the submitting party in exchange for the management of the contest and the risk involved in offering prizes.

In one embodiment, a web site can be combined with a savings or other account to which content providers transfer money, and then use that money for all or part of their enrollment fee to enroll in a contest. By paying a fee that is then used for multiple contest entry fees, each provider saves himself and the contest manager the cost of credit card fees or other transaction fees for every contest entry. He then uses his credits to pay the fee for uploading content and entering the contest. His winnings, if any, are deposited into the “savings account” for later use in entering contests.

For example, a woman may deposit $20 in her account to join the web site. She then uses $2 to enter the contest, permitting her to upload a video or a collection of photographs. This leaves a balance of $18 in the account. At the end of the week, she may have won a prize in the contest, such as $140 for 8th place. The money won is deposited automatically into her account, bringing the balance to $158. She can withdraw her money at any time, or can continue to use it for entering future contests. In either case, the web site company can receive interest on the deposited money and saves the cost associated with credit card transactions.

The creation of an account also provides a means for collecting contact information for providers of content, so that such providers can be notified if they win a prize. The creation of an account, even without the transfer of money into or out of the account, can be required in order to collect this necessary information.

The invention can be used with existing web sites that already contain content. For example, a tracking method can be used on the MySpace web site (www.myspace.com) or other web sites that receive and display content to the public generally. In this example, the participant with the greatest number of visitors over a given time wins a prize.

The invention can also be used in conjunction with the YouTube web site (www.youtube.com), which is a web site that permits people to upload and display video, and avoids the need to create a web site for display. In this example, the video viewed the most times wins a prize. The critical feature is that the producer of the video or other content earns money, prizes or other valuable consideration (including intangibles, such as notoriety, frame and/or exposure of their work to mass audience) based on the popularity of the video among the viewing public.

Of course, another means by which media content can be determined to be the most popular include voting or rating the content on a scale, such as 1 to ten, or by rating multiple features of the content, such as creativity, execution, suitability for young audiences, etc. In this embodiment, viewers of a file rate the content, and this rating is compiled, such as by the web site company's server, and presented to viewers.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A method of encouraging the submission of media content to a web site that provides means for uploading media and viewing media content, the method comprising the steps of:
(a) announcing the means for uploading and viewing the media and consideration that will be given to any party submitting a most popular content file;
(b) tracking the viewing of a plurality of submitted content files on the web site;
(c) determining which content file, among the plurality of submitted content files, is the most popular; and
(d) awarding consideration to at least the provider of the most popular content file.

2. The method in accordance with claim 1, wherein the step of determining further comprises counting the number of times each of said plurality of submitted content files was viewed and marking the content file that was viewed the most times as the most popular.

3. The method in accordance with claim 1, wherein the step of awarding consideration further comprises awarding money.

4. The method in accordance with claim 1, wherein the step of tracking further comprises tracking the viewing of the files over a predetermined period of time.

5. The method in accordance with claim 4, wherein the step of determining further comprises counting the number of times the content was viewed in the predetermined period of time and marking the content that was viewed the most times as the most popular.

6. The method in accordance with claim 1, further comprising the step of charging a fee to upload a content file.

7. The method in accordance with claim 1, further comprising the steps of creating an account and transferring money into the account.

8. The method in accordance with claim 7, further comprising the step of transferring at least some of the money out of the account in payment of a fee to upload a content file.

9. The method in accordance with claim 3, further comprising the steps of creating an account and transferring at least some of the money awarded into the account.

10. The method in accordance with claim 1, wherein the step of awarding consideration further comprises awarding consideration to providers of other content files.

11. A method of encouraging the submission of media content to a web site that provides a means for uploading media and viewing media content, the method comprising the steps of:
(a) announcing the means for uploading and viewing the media and consideration that will be given to a party submitting a most popular content file;
(b) tracking the viewing of the content files on the web site over a predetermined period of time;
(c) comparing the number of times each of said plurality of submitted content files was viewed and marking the content file that was viewed the most times as the most popular; and
(d) awarding money to at least the provider of the most popular content file.

12. The method in accordance with claim 11, further comprising the steps of:
(a) charging a fee to upload a content file;
(b) creating an account;
(c) transferring money into the account;
(d) transferring at least some of said money out of said account in payment of said fee; and
(e) transferring at least some of the money awarded into the account.
